(19) United States
(12) Patent Application Publication
(10) Pub. No.: US 2026/0053130 A1
(43) Pub. Date: Feb. 26, 2026

(54) NEBULIZER

(71) Applicant: GUARANY INDÚSTRIA E COMÉRCIO LTDA., Itú (BR)

(72) Inventor: ALIDA MARIA FLEURY, São Paulo (BR)

(21) Appl. No.: 19/243,717

(22) Filed: Jun. 20, 2025

(30) Foreign Application Priority Data
Aug. 23, 2024 (BR) 102024017363-5

(51) Int. Cl. A01M 1/20

(52) U.S. Cl. CPC A01M 1/2027

(57) ABSTRACT

The invention belongs to the sector of combating endemic diseases. It is an insecticide aerosol nebulizer on platform for pickup trucks. It has means of selecting and/or nebulizing adulticides, larvicides or cleaning. The nebulizer comprises an autonomous set of air flow (1) comprised of a combustion engine (11) of low power with a fuel tank (12) that activates a blower (13) (lobe pump) for atomization of the insecticide in the atomization nozzle (2); multiple set of reservoirs (3) comprised of larvicide reservoir (31); adulticide (32) and cleaning fluid (33) mounted in housing (34); hydraulic circuit (5) comprising larvicide/cleaning directional valve (V1); adulticide/cleaning (V2); electric pump (51) diaphragm; larvicide shut-off/release valve (V3); adulticide (V4); return (V5); flow control (V6); output directional (V7); junction (52) and duct (53). Stirring (6) comprises directional stirring valve (61); tube (62); lid (63) and relief (64).

### TECHNICAL SECTOR

The present invention belongs to the technological sector of machinery and equipment to combat endemics, more specifically it refers to an aerosol insecticide nebulizer mounted on a platform for pickup trucks for the control of pests such as mosquitoes, flies, cockroaches and other insects. The nebulizer has versatile means for the selection and nebulization of adulticides and/or larvicides, ensuring a high distribution rate of the insecticide in outdoor environments.

The present invention comprises a reservoir for larvicide; a reservoir for adulticide; and a reservoir for water. The equipment has an autonomous air pressurization set, driven by a low-power internal combustion engine with an integrated fuel tank. Said engine drives a direct-displacement air pressurizer, responsible for atomizing the insecticide particles for misting through the nozzle. The hydraulic circuit comprises a pump for the reservoirs and a system of directional control and flow block valves that select between larvicide nebulization; adulticide nebulization and cleaning of the hydraulic circuit.

### STATE OF THE ART

ULV nebulizers are present in the state of the art, producing a fine mist of droplets from 5 to 30 micrometers for vector control and disinfection. These pieces of equipment operate through main components such as the motor, compressor, electric pump, regulating valves, filters, tanks for the reservoir of chemical products such as insecticides, and a misting nozzle to generate the mist. They can be equipped with a single tank or in some models be equipped with a tank for insecticidal chemical product and a tank for water or other product for cleaning the hydraulic circuit. They operate by atomizing the chemical liquid into fine particles that are dispersed in the air.

The patent document U.S. Pat. No. 4,992,206 A describes an aerosol generator used to disperse pesticides, herbicides and other chemicals, with a remote-controlled instantaneous shutdown system. The generator is composed of a motor, a blower, and nozzle sets, where the chemical is dispersed in droplets of 5 to 20 microns. The equipment can be mounted on vehicles for spraying in residential areas. The generator includes two main reservoirs: a tank to store the chemical, such as insecticide, and an auxiliary tank for cleaning the system. The chemical tank is constructed of corrosion-resistant material, suitable for storing chemical substances. Its capacity varies according to the application. The cleaning tank is used to purge the nozzles and misting system after use, preventing the mixing of different products and wear and tear on the pumping components due to the chemical attack of the insecticide. Both tanks are integrated into the generator for optimized use.

The Super pro stationary cold fogger model, manufactured by pulsFOG Pulverizadores in Brazil, is a cold UBV aerosol generator, designed for professional applications in the control of pests and diseases, such as dengue fever. This equipment, mounted on vehicles, is designed for mosquito fighting campaigns in large areas. The model has two main reservoirs: a formulation tank with a capacity of 60 liters, intended for the storage of insecticides, and a 5-liter washing tank, used for cleaning the system after use, preventing deterioration of the equipment's pumping system. The operation of the generator involves a powerful 18 HP gasoline engine, which drives a blower for nebulizing insecticide in ultrafine droplets, with a diameter of less than 20 micrometers, by means of a nebulization nozzle with full movement.

The ULV nebulizers available in the state of the art have significant limitations due to the lack of projectability for multiple distinct reservoirs, intended for different chemicals. Currently, this equipment usually has a single reservoir for the insecticide or, in some cases, two separate reservoirs: one for the insecticide and one for the cleaning fluid. Although the presence of a reservoir for cleaning facilitates the transition between products, promoting the cleaning of the hydraulic system (pumping), the equipment is still restricted to a single type of insecticide per operation. When it is necessary to change the type of insecticide, the user must remove the current chemical and manually perform a thorough cleaning of the reservoir before adding the new insecticide. This cleaning process is crucial to prevent cross-contamination, but it results in increased equipment downtime and can compromise the effectiveness of the new insecticide if not performed properly, leading to less efficient application and potential degradation of equipment performance. These limitations represent significant challenges to continuous and efficient operation in situations that require the use of different insecticides.

### NOVELTIES AND OBJECTIVE OF THE INVENTION

The objective of the present invention is a compact aerosol insecticide nebulizer that effectively solves the limitations of the previously mentioned state of the art.

The nebulizer is designed to be mounted on a platform for pickup trucks, intended for the control of pests such as mosquitoes, flies, cockroaches and other insects. It has a system that allows the user to choose the type of insecticide to be sprayed, whether larvicide or adulticide using the same equipment, without the need to interrupt the service to change the products inside the reservoirs.

The compact aerosol insecticide nebulizer, described in this patent application, has a set of three distinct reservoirs: one for larvicide, one for adulticide and one for water (cleaning fluid). The equipment is endowed with an autonomous air pressurization system, which is driven by an internal combustion engine with an integrated fuel tank. This engine drives an air blower, responsible for atomizing the insecticide particles for their nebulization through the insecticide nebulization nozzle. The nebulizer also includes a unique hydraulic circuit that controls the operation of the three reservoirs. Said hydraulic circuit comprises a pump and a system of directional control and flow block valves arranged in order to allow the user to select the mode of use between larvicide nebulization, adulticide nebulization, and cleaning of the hydraulic circuit, without the need to stop the equipment.

Optionally, the nebulizer can be equipped with a stirring system for the chemical fluids in the larvicide and adulticide reservoirs. This system allows the user to mix the products before application, avoiding the decantation of the chemical.

### ADVANTAGES AND TECHNICAL EFFECTS OF THE INVENTION

The aerosol insecticide nebulizer of the invention, results in the following advantages and achieves the following technical effects over the systems of the state of the art:
Operational Versatility: The invention has three distinct reservoirs (for larvicide, adulticide and cleaning fluid), allowing the alternation between different types of insecticides and the cleaning of the system without interrupting the operation of the equipment;
Reduction of Downtime: The integration of three distinct reservoirs eliminates the need for breaks to change products and perform system cleaning;
Agile and Simple Control: The integrated hydraulic circuit, with pump and system of directional control and flow blocking valves, allows you to quickly select between larvicide spraying, adulticide spraying and circuit cleaning;
Chemical Stirring: For chemicals that require stirring, the stirring system for the larvicide and adulticide reservoirs ensures proper mixing of the chemicals before and during application, ensuring that the nebulization cloud contains the exact concentration of the insecticide;
Prevention of Cross-Contamination: The directional control and flow block valve system associated with the stirring option ensures the prevention of cross-contamination between different chemicals.

### LIST OF ACCOMPANYING DRAWINGS

In order for this invention to be fully understood and put into practice by any person skilled in the art, it is now described in a clear, precise and sufficient manner, based on the accompanying drawings, listed below:

FIG. 1—Perspective view of the nebulizer;

FIG. 2—Perspective view of the autonomous air flow assembly;

FIG. 3—Exploded perspective view of the nebulizer;

FIG. 4—Hydraulic circuit configured for larvicide nebulization;

FIG. 5—Hydraulic circuit configured for adulticide nebulization;

FIG. 6—Hydraulic circuit configured for cleaning the circuit in the larvicide lines;

FIG. 7—Hydraulic circuit configured for circuit cleaning in adulticide lines;

FIG. 8—Pneumatic circuit for stirring of insecticidal agents;

FIG. 9—Optional hydraulic circuit.

### DETAILED DESCRIPTION OF THE INVENTION

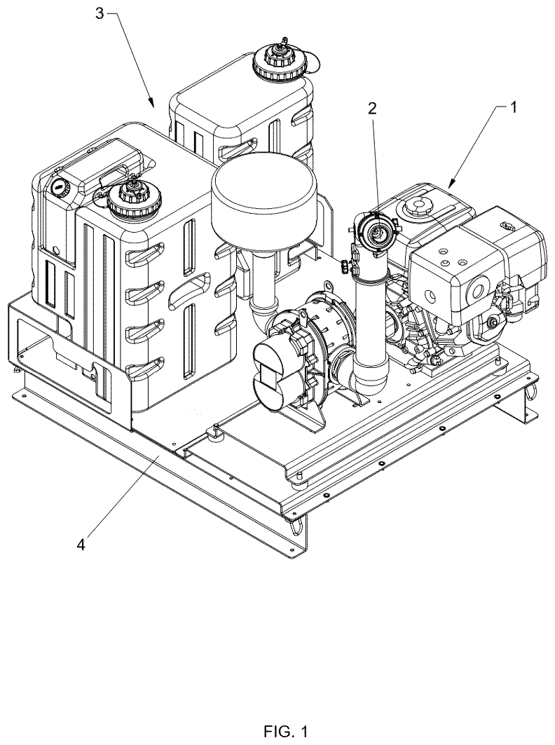

FIG. 1 illustrates the aerosol insecticide nebulizer comprising a self-contained air flow set (1) with an atomizing nozzle (2) and a multiple set of reservoirs (3) arranged on a compact platform (4).

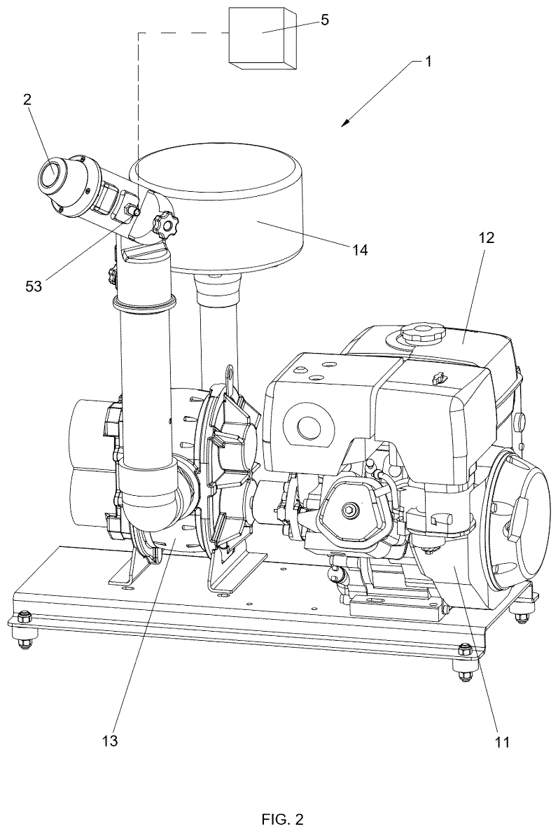

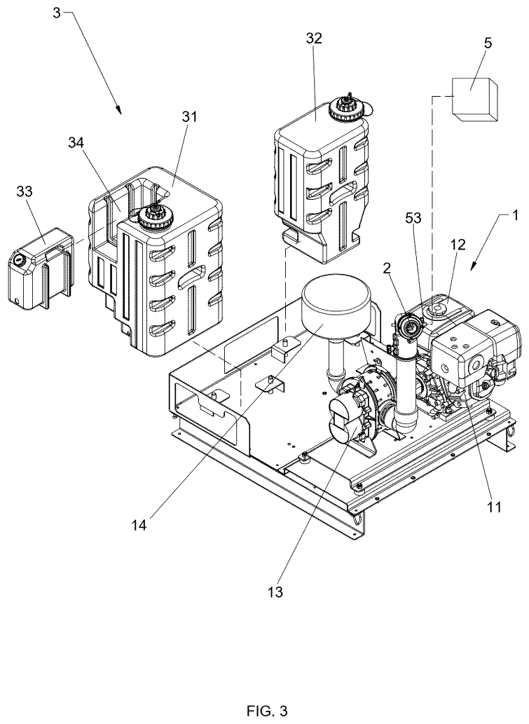

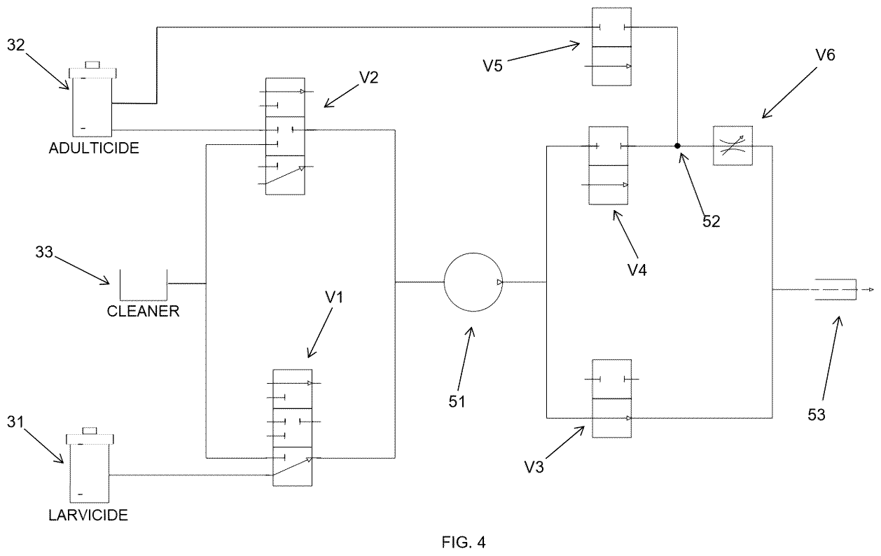

FIGS. 2 and 3 detail the autonomous set of air flow (1) and multiple set of reservoirs (3). The aforementioned autonomous air flow set (1) comprises a low-power internal combustion engine (11) equipped with an integrated fuel tank (12), responsible for driving a blower (13). Preferably the blower (13) is a positive displacement lobe pump that generates the airflow for the atomization of the insecticide inside the atomization nozzle (2), whose airflow generated by the blower (13) mixes with the selected insecticide, which is simultaneously introduced through the supply duct (53) from the hydraulic circuit (5), whose function is better specified in FIGS. 4 to 6. Further, said blower (13) is equipped with an air filter (14) to prevent any physical particles from entering the interior of the blower (13) and/or the atomizing nozzle (2).

The interaction between the air flow and the flow of the selected insecticide generates the formation of particles that constitute the appropriate mist to combat endemics. Said multiple set of reservoirs (3) comprises a larvicide reservoir (31); adulticide reservoir (32) and cleaning fluid reservoir (33). Optionally, the larvicide reservoir (31) is equipped with housing (34) for encasing the cleaning fluid reservoir (33).

FIG. 4 illustrates the hydraulic circuit (5) of the compact nebulizer, which comprises the following components:
a) larvicide reservoir (31);
b) adulticide reservoir (32);
c) cleaning fluid reservoir (33);
d) larvicidal/cleaning directional valve (V1);
e) adulticidal/cleaning directional valve (V2);
f) electric pump (51);
g) larvicide block/release valve (V3);
h) adulticide block/release valve (V4);
i) adulticide return release/block valve (V5);
j) flow control valve for the adulticide (V6);
k) junction (52); and
l) insecticide feed duct (53) in the nozzle (2).

The invention's compact aerosol insecticide nebulizer comprises a system that allows the user to select the type of insecticidal chemical to be nebulized as needed, either to combat pests in the larval stage (larvicide) or in the adult stage (adulticide). The equipment also includes a hydraulic circuit cleaning system (5) for insecticide or cleaning fluid selection, ensuring operational efficiency is maintained.

FIG. 4 also illustrates the hydraulic circuit (5) with the positioning of directional valves and block/release valves when the user selects the larvicide nebulization option. In this mode of use, the pump (51) sucks the fluid from the larvicide reservoir (31) through the larvicide/cleaning directional valve (V1) and the larvicide block/release valve (V3) respectively and directs it to the supply duct (53) of the nozzle (2). Preferably the electric pump (51) is a diaphragm pump. The feed duct (53) supplies the larvicide liquid inside the atomization nozzle (2), illustrated in FIGS. 2 and 3. The adulticide/cleaning directional valve (V2), adulticide block/release valve (V4), and return block/release valve (V5) are in the flow block position to prevent the fluid from the adulticide reservoir (32) and cleaning fluid reservoir (33) from being contaminated with the fluid in the larvicide reservoir (31).

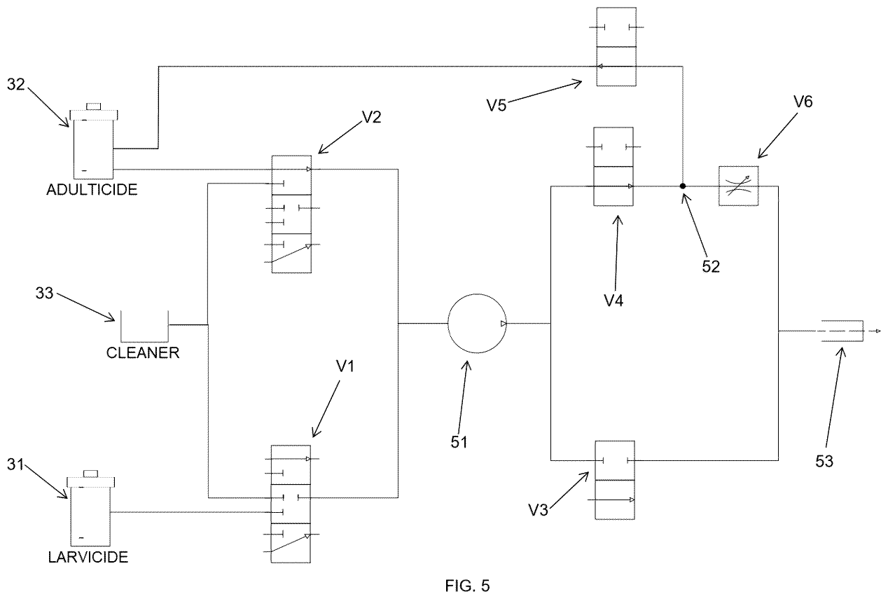

FIG. 5 illustrates the hydraulic circuit (5) with the placements of the directional valves and shut/release valves when the user selects the adulticide nebulization option. In this mode of use, the pump (51) sucks the fluid from the adulticide reservoir (32) through the adulticide/cleaning directional valve (V2); adulticide block/release valve (V4) which is in the flow release position, and flow control valve (V6) to the feed duct (53) of the nozzle, respectively. The supply duct (53) supplies the adulticidal liquid inside the atomizing nozzle (2), illustrated in FIGS. 2 and 3.

Said flow control valve (V6) limits the outflow of the adulticide, given that its application requires lower flow rates compared to that of larvicides. To avoid overloading the hydraulic circuit (5) during flow control, a junction (52) was positioned between the adulticide block/release valve (V4) and the flow control valve (V6) to direct the flow of surplus adulticide through a return block/release valve (V5), which, in the flow release position, conducts the surplus of the adulticide back to the adulticide reservoir (32). This system provides greater ease and speed in the adjustments of low flow rates (less than 100 ml/min). The larvicide/cleaning directional valve (V1) and larvicide block/release valve (V3) are in the flow block position to prevent the fluid from the larvicide reservoir (31) and cleaning fluid reservoir (33) from being contaminated with the fluid from the adulticide reservoir (32).

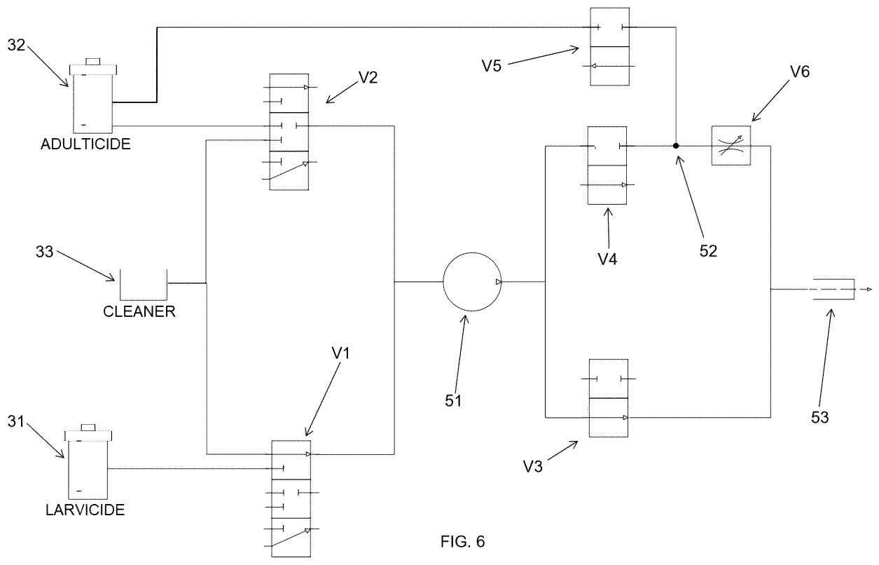

FIG. 6 illustrates the hydraulic circuit (5) with the positioning of the directional valves and block/release valves when the user selects the selection hydraulic circuit cleaning option (5) in the larvicide flow line. In this mode of use, the pump (51) moves the fluid from the cleaning fluid reservoir (33) through the larvicide/cleaning directional valve (V1) and the larvicide block/release valve (V3) which is in the flow release position to the supply duct (53) of the atomizing nozzle (2) respectively. In this mode of operation, the adulticide/cleaning directional valve (V2), adulticide block/release valve (V4), and return block/release valve (V5) are in the flow block position to prevent the cleaning fluid reservoir fluid (33) from contaminating the adulticide reservoir fluid (32).

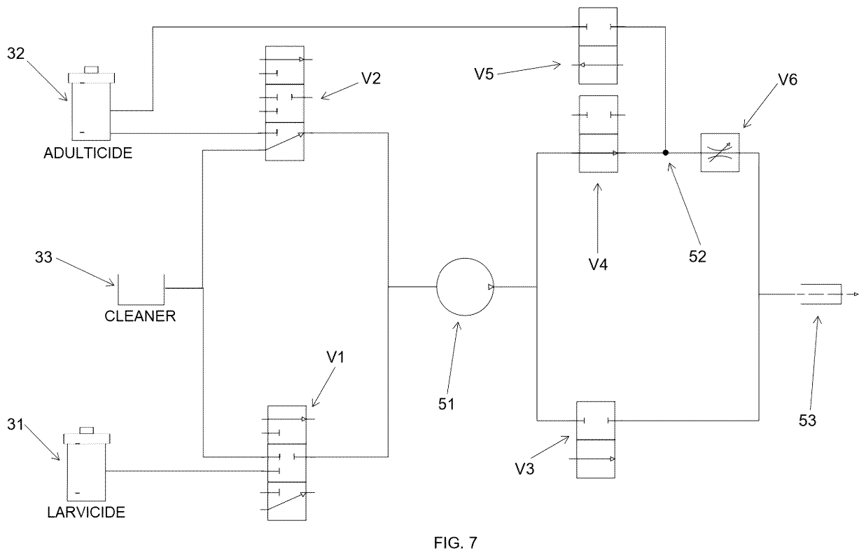

FIG. 7 illustrates the hydraulic circuit (5) with the placements of the directional valves and block/release valves when the user selects the hydraulic circuit cleaning option (5) in the adulticide flow line. In this mode of use, the pump (51) moves the fluid from the cleaning fluid reservoir (33) through the adulticidal/cleaning directional valve (V2); adulticide block/release valve (V4) which is in the flow release position, and flow control valve (V6) to the supply duct (53) of the atomizing nozzle (2), respectively. In this mode of operation, the larvicide/cleaning directional valve (V1), larvicide block/release valve (V3), and block/return release valve (V5) are in the flow block position to prevent the fluid from the cleaning fluid reservoir (33) from contaminating the fluid in the larvicide reservoir (31) and adulticide reservoir (32).

Preferably the larvicide block/release (V3), adulticide block/release (V4) and adulticide return block/release (V5) valves are two-way valves. The larvicide/cleaning (V1) and adulticide/cleaning (V2) directional valves are three-way valves.

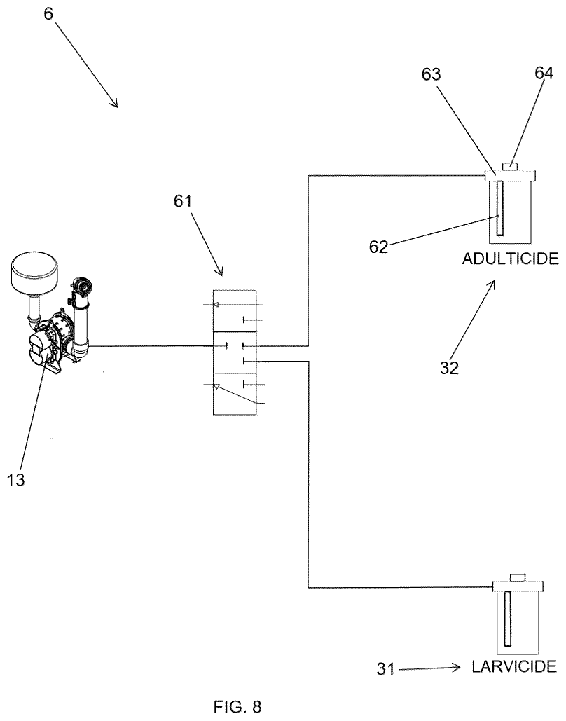

As illustrated in FIG. 8, the nebulizer can optionally be equipped with a system for stirring (6) the insecticidal liquids in the larvicide (31) and adulticide (32) reservoirs comprising the following elements:
a) Directional stirring valve (61);
b) Fishing pipe (62);
c) Lids (63) and
d) Relief valve (64).

The stirring system (6) ensures the homogenization of the insecticide, optimizing its application. The larvicide (31) and adulticide (32) reservoirs are connected to a directional stirring valve (61), which is attached to the air blower (13). This directional stirring valve (61) allows the selection of the reservoir that will receive the air from the blower (13). The air is conducted to the bottom of the reservoirs by means of a fishing tube (62) installed in the lids (63), promoting the stirring of the insecticidal liquids. To prevent excess pressure and possible damage, the caps (63) have relief valves (64) that release excess pressure into the atmosphere.

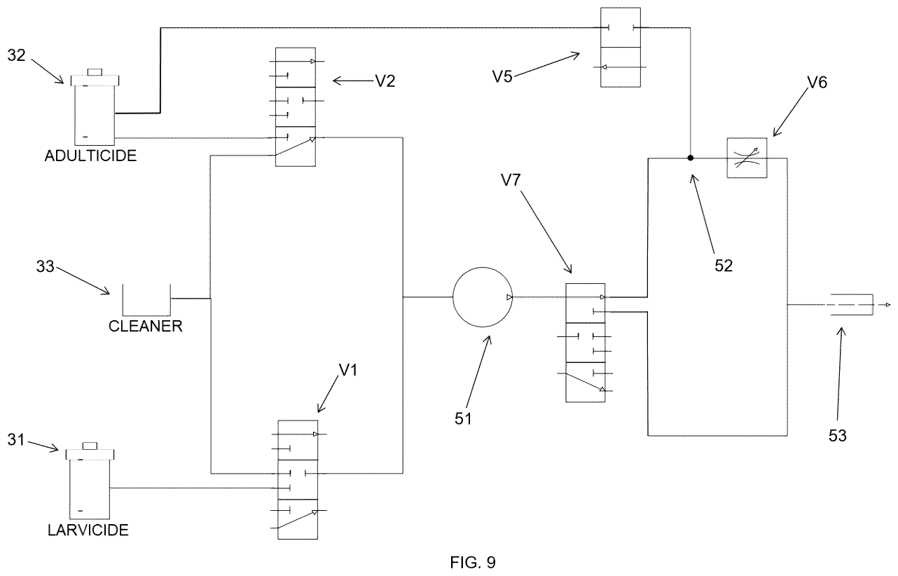

According to FIG. 9 and also optionally, the hydraulic circuit (5) can comprise a single directional outlet valve (V7) as a replacement for the larvicide block/release (V3) and adulticide block/release (V4) valves, illustrated in FIGS. 4 to 7.

1. A NEBULIZER aerosol insecticide comprising a self-contained air flow assembly (1) with an atomizing nozzle (2) and a multiple set of reservoirs (3) arranged on a compact platform (4), the self-contained air flow assembly (1) comprises an internal combustion engine (11) provided with a fuel tank (12) that drives the blower (13) provided with an air filter (14), characterized by the multiple set of reservoirs (3) comprising a larvicide reservoir (31), adulticide reservoir (32) and cleaning fluid reservoir (33); the hydraulic circuit (5) comprising a larvicide/cleaning directional valve (V1), an adulticide/cleaning directional valve (V2), an electric pump (51), a larvicide block/release valve (V3), adulticide block/release valve (V4), an adulticide return block/release valve (V5), an adulticide flow control valve (V6), a junction (52) and an insecticide feed duct (53) inside the atomizing nozzle (2).

2. A NEBULIZER aerosol insecticide comprising a self-contained air flow assembly (1) with an atomizing nozzle (2) and a multiple set of reservoirs (3) arranged on a compact platform (4), the self-contained air flow assembly (1) comprises an internal combustion engine (11) provided with a fuel tank (12) that drives the blower (13) provided with an air filter (14), characterized by the multiple set of reservoirs (3) comprising a larvicide reservoir (31), adulticide reservoir (32), and cleaning fluid reservoir (33); the hydraulic circuit (5) comprising a larvicide/cleaning directional valve (V1), an adulticide/cleaning directional valve (V2), an electric pump (51), a single three-way directional outlet valve (V7) for feeding the insecticide liquid into the supply duct (53) of the atomizing nozzle (2), an adulticide return block/release valve (V5), an adulticide flow control valve (V6), and a junction (52).

3. THE NEBULIZER according to either of claims 1 or 2, characterized by the larvicide block/release valve (V3), adulticide block/release valve (V4) and adulticide return block/release valve (V5) being two-way valves; the larvicidal/cleaning directional valve (V1) and adulticidal/cleaning directional valve (V2) being three-way valves.

4. THE NEBULIZER, according to either claim 1 or 2, characterized by being blower (13) a positive displacement lobe pump.

5. THE NEBULIZER, according to either claim 1 or 2, characterized in that the electric pump (51) is a diaphragm pump.

6. THE NEBULIZER according to either of claims 1 or 2, characterized by being the larvicide reservoir (31) provided with housing (34) to receive the cleaning fluid reservoir (33).

7. THE NEBULIZER according to either of claims 1 or 2, characterized by being the nebulizer equipped with a system of stirring (6) of the fluids of the larvicide (31) and adulticide (32) reservoirs.

8. THE NEBULIZER, according to claim 7, characterized in that the stirring system (6) comprises a stirring directional valve (61); fisher tube (62); cover (63); and relief valve (64).
